(19) United States
(12) Patent Application Publication
(10) Pub. No.: US 2019/0221018 A1
(43) Pub. Date: Jul. 18, 2019

(54) Method for evaluating a visual design and identifying changes which will improve visual harmony

(71) Applicant: James Bunch, Boulder, CO (US)

(72) Inventor: James Bunch, Boulder, CO (US)

(21) Appl. No.: 15/869,878

(22) Filed: Jan. 12, 2018

(51) Int. Cl. G06T 11/60; G06T 11/20

(52) U.S. Cl. CPC G06T 11/60; G06T 11/206

(57) ABSTRACT

A comprehensive method is provided which can be used to evaluate a visual design and to identify changes which will improve visual harmony. Visual harmony is defined as a pleasing sensation which is the result of combing visual design variables in a visual design. There are six visual design variables which are important when evaluating a visual design. The visual design variables are value, color, color intensity, texture, line, and shape. An artist using this method will be able to improve their designs because they will have the ability to evaluate their designs and they will have the ability to identify appropriate changes to visual design variables which will improve visual harmony.

### CROSS REFERENCE TO RELATED APPLICATIONS

Not Applicable.

### STATEMENT OF FEDERALLY SPONSORED RESEARCH OR DEVELOPMENT

Not Applicable.

### BACKGROUND OF THE INVENTION

Evaluating a visual design (e.g. painting, photograph, interior design) to determine what is appealing about the design can be difficult. A design can be extremely complex and involve hundreds of objects of varying shapes, colors, textures and lines. The task of evaluating all the visual objects to determine which objects provide positive emotions and which ones provide negative emotions can be mind boggling. Currently, there are numerous books and software products available which offer techniques and software tools for creating designs but there is an absence of resources available to evaluate a design and to identify changes to a design which will improve visual harmony.

### BRIEF SUMMARY OF THE INVENTION

The invention provides a method which can be used to evaluate a visual design and to identify changes which will improve visual harmony. Visual harmony is defined as a pleasing sensation which is the result of combining visual design variables in a design. There are six visual design variables which are important when evaluating a design. The visual design variables are value, color, color intensity, texture, line, and shape. Artists using this invention will be able to improve their designs because they will have the ability to evaluate their designs and they will have the ability to identify appropriate changes to visual design variables which will improve visual harmony.

The invention involves four steps. The steps are illustrated in FIG. 1. The first step (110) uses five techniques to evaluate a visual design. Each technique is based on a design principle which affects visual harmony. After the design has been evaluated, the next step is to identify possible changes to the design (120). The design changes are based on identifying changes to the visual design variables which will improve visual harmony. If there are no design changes then the design is complete (130). If changes are noted then the changes are applied to the visual design (140). After the changes are completed then the design is evaluated again in (110). This process is iterative until there are no more changes. At this point the visual design is complete.

### BRIEF DESCRIPTION OF THE SEVERAL VIEWS OF THE DRAWING

FIG. 1 illustrates an overview of the invention. The invention is comprised of four steps which are described by boxes and triangles in FIG. 1.

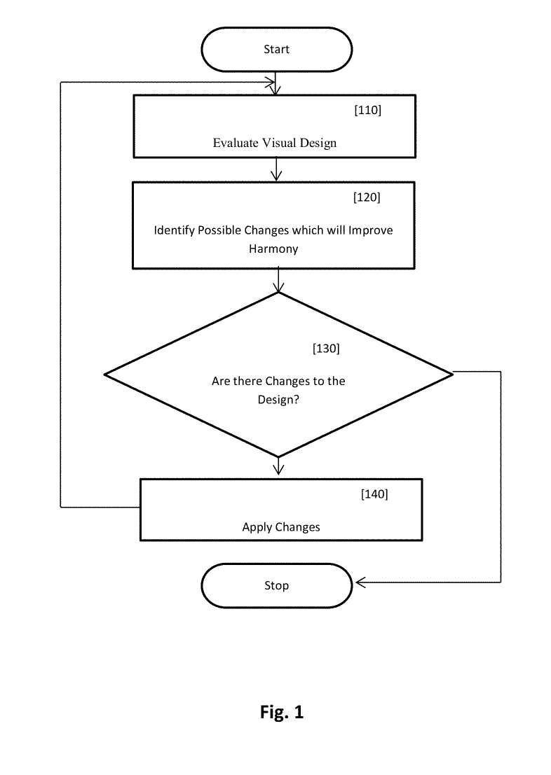

FIG. 2 illustrates three design principles which are used to create visual bars. Visual bars are used to evaluate a visual design for harmony.

FIG. 3 illustrates an example of a visual design being evaluated.

FIG. 4 illustrates an example of how a visual design can be modified.

### DETAILED DESCRIPTION OF THE INVENTION

The invention involves four steps (see ‘Brief Summary of the Invention’ for an overview of the four steps). The first step (110) is the most important step. This step evaluates the visual design using five techniques. Each technique is based on a design principle. The five design principles are dominance, opposition, balance, unity and rhythm.

The first design principle is dominance. Dominance is when the viewer feels harmony because a visual design variable is perceived to be dominant in size and area. A visual design variable which is perceived to be dominant in size and area is referred to as a dominant element. For example, a shape can be a dominant element. The following list describes the six dominant elements:
1. Value (e.g. black, grey, white)—Value is the lightness and darkness of an object. Value becomes a dominant element when the value of the visual design accounts for more than 50% of the perceived total area.
2. Color (e.g. color wheel)—Color is the different wavelengths of visible light of an object. Color becomes a dominant element when the color of the visual design accounts for more than 50% of the perceived total area. The total area only applies to the area which has color.
3. Color intensity (i.e. color strength)—Color intensity is the amount of pure color of an object. An object that is reflecting pure color is considered saturated with color. Color intensity becomes a dominant element when the color intensity of the visual design accounts for more than 50% of the perceived total area. The total area only applies to the area which has color.
4. Texture—Texture is the physical tactile appearance of an object. Texture becomes a dominant element when the texture of the visual design accounts for more than 50% of the perceived total area. The total area only applies to the area which has visual objects.
5. Line—A line is a thin object which implies very little volume. Line becomes a dominant element when the line direction accounts for more than 50% of the perceived total line direction.
6. Shape—A shape is an object which has external boundaries and implies volume. A shape becomes a dominant element when the shape appears larger than 50% of the perceived total area under consideration.

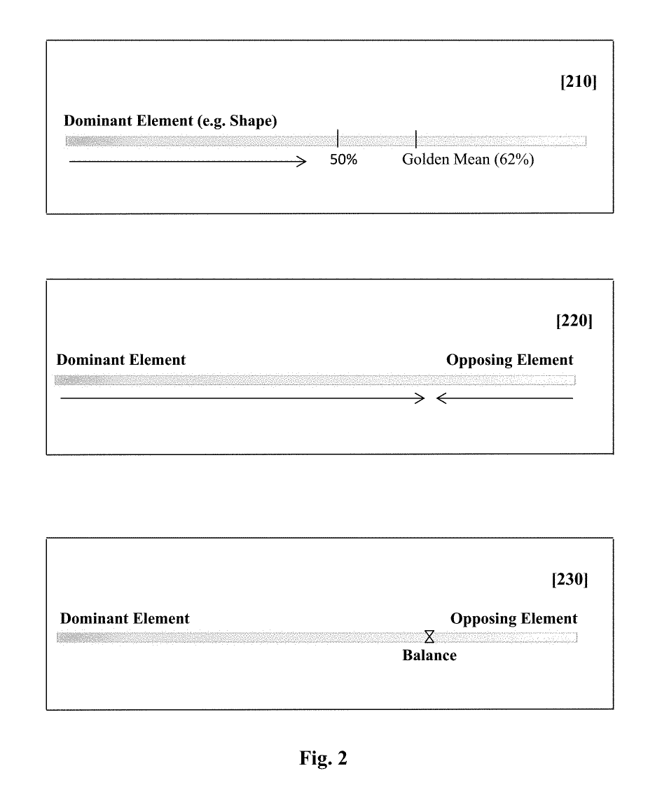

The following visual bar (210) in FIG. 2 represents the perceived area of a visual design. The perceived area is often equal to the actual area but not always. Sometimes it is difficult to measure the actual area (e.g. series of lines). In cases where it is difficult to measure the actual area, the perceived area is used. The perceived area is the viewer's best judgment as to what constitutes size. Also, another consideration when determining perceived size is the manner in which the viewer's eye is focused on a visual design. Initially, most people probably focus on the entire visual design then they proceed to focus on specific objects which catch their attention. In situations where the eye is focused on a specific location, then the perceived area includes the area where the eye is focused on.

In FIG. 2 (210), the dominant element for the bar is a shape. The perceived area of the shape needs to be greater than 50% in order for the visual design variable to be a dominant element. For best results, the preferred area size is approximately 62%. This size represents the golden mean. The golden mean is considered the best size for visual designs. The golden mean is an approximation. The artist should always use their best judgment when deciding how large to make a dominant element.

The second design principle which affects visual harmony is opposition. Opposition is when the artist adds a visual design variable which opposes a dominant element. This application refers to an opposing visual design variable as an opposing element. When the artist adds an opposing element to a dominant element, the artist can increase harmony beyond what is achievable from dominance alone. For example, the artist can improve harmony by adding a shape to the visual design which opposes the dominant shape. However, the artist can only add a certain amount of shape to improve harmony. If the artist adds too much shape then the artist can create disharmony. The correct amount to add is entirely dependent on the artist. However, according to the golden mean, the preferred area size is approximately 38% (i.e. 62% dominant element, 38% opposing element). The golden mean ratio of 62/38 should not override the artist's judgment. The artist's preference should be the deciding factor. Also, the subject matter is extremely important. The subject matter can determine the size of the dominant and opposing elements.

The following list describes six opposing elements which can be used with a corresponding dominant element:
1. Value—Value can be used to oppose the dominant value by including a value which is opposite of the dominant value. For example, dark grey versus light grey or white versus black.
2. Color (hue)—Color can be used to oppose the dominant color by including a color which is opposite on the color wheel.
3. Color intensity—Color intensity can be used to oppose the dominant color intensity by including an opposite color intensity. For example, brilliant red versus dull red.
4. Texture—Texture can be used to oppose the dominant texture by including a texture which is significantly different than the dominant texture. For example, smooth versus rough texture.
5. Line—A line can be used to oppose the dominant line direction by including a line which is in the opposite direction of the dominant line. For example, horizontal versus vertical lines.
6. Shape—A shape can be used to oppose a dominant shape by including a shape which is perceived to be significantly different than the dominant shape. The opposing shape is usually smaller in size and is perceived to be in conflict with the dominant shape. Deciding whether or not a smaller shape is an opposing shape can be difficult sometimes. If the opposing and dominant shapes have different sizes, opposite values and different colors then it is usually easier to make the distinction between an opposing shape and a dominant shape.

The following visual bar (220) has been modified to include an opposing element. The opposing element perceived size must be less than 50% to be considered an opposing element. The opposing element is measured from right to left and the dominant element is measured from left to right.

The third design principle which affects visual harmony is balance. Balance is when the artist maximizes harmony by adding the right amount of opposing element to a dominant element. The right amount is dependent on the artist. The golden mean can be used in situations where the artist is unsure of the right amount. Balance is represented by the ‘X’ symbol on the visual bar (230). As you move the symbol from right to left, you increase the opposing element perceived size and you decrease the perceived size of the dominant element.

Unity is the fourth design principle. Unity is when the artist alters an opposing element so that it copies a dissimilar dominant element visual characteristic. Unity can be measured by listing all the opposing elements for the visual design and then listing all the dissimilar dominant elements where the visual characteristics are being copied by the opposing elements.

For example, if a visual design includes a complementary color scheme of blue (dominant element) and orange (opposing element) and a dominant light value then you can use unity by altering the orange color so it has a light value. In this example, harmony is created by uniting the orange color (opposing element) with a dissimilar dominant element (i.e. light value).

Rhythm is the fifth design principle which the artist can use to improve harmony. The artist can add rhythm to their visual design by using multiple occurrences of opposing elements. There are six visual design variables (i.e., value, color, color intensity, texture, line, shape) which the artist can use repetitively in their visual design. Also, the artist can create rhythm by using a color and/or value sequence. A sequence for color and value is when the visual design variable increases or decreases incrementally thereby creating a gradient of color and value.

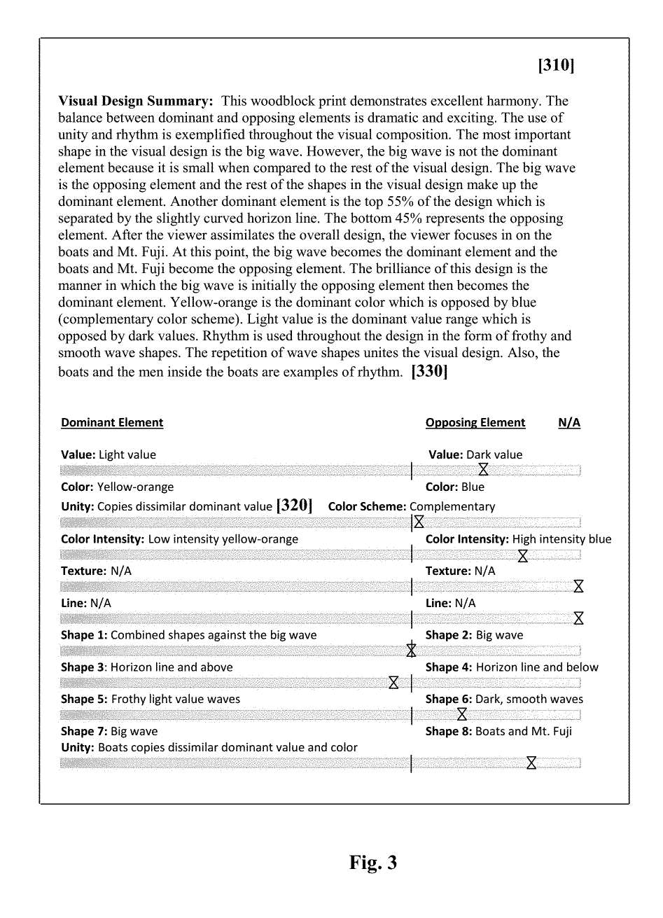

The nine visual bars (310) in FIG. 3 are an example of the techniques which are used to evaluate a visual design. The visual bars can be represented by a computer program (e.g. slider bar display tool) or the visual bars can be represented in a paper document. Each visual bar represents three evaluation techniques based on three design principles (i.e. dominance, opposition, and balance). Unity is the fourth evaluation technique. Unity information is provided in the narrative next to the ‘Unity:” prompt (320). Rhythm is the fifth evaluation technique. Rhythm information is provided in the narrative next to the ‘Visual Design Summary:’ prompt (330). Also, the summary narrative provides an overall evaluation of the visual composition using the five techniques based on the five design principles (i.e. dominance, opposition, balance, unity and rhythm).

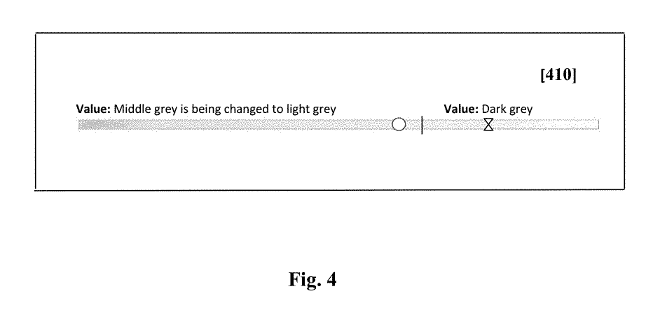

Step 2 (120) can be initiated after the visual design has been evaluated for harmony. Step 2 identifies possible changes to the design. The design changes are based on identifying changes to the visual design variables which will improve visual harmony. The visual bar (410) in FIG. 4 represents a design change for value. In this example, the middle grey is being changed to light grey. Also, the perceived area for dark grey is being increased and the dominant value of middle grey is being reduced. The visual bar represents this change by using the ‘O’ symbol. This symbol is to the left of the balance symbol which means that the opposing element is increasing in size and the dominant element is being reduced in size.

If there are no design changes then the design is complete (130). If changes are noted then the changes are applied to the visual design (140). After the changes are completed then the design is evaluated again in (110). This process is iterative until there are no more changes. At this point the visual design is complete.

What is claimed:

1. A method for evaluating a visual design, wherein said method comprises the steps of:
a. Determining dominance for visual design variables;
b. Determining opposition for visual design variables;
c. Determining balance for visual design variables;
d. Determining unity for visual design variables;
e. Determining rhythm for visual design variables;
f. Providing visual bars, balance symbol and narrative summaries that describes the evaluation;

2. The method of claim 1 wherein the step of determining dominance for visual design variables comprises the steps of:
a. Determine dominance for value;
b. Determine dominance for color;
c. Determine dominance for color intensity;
d. Determine dominance for texture;
e. Determine dominance for line;
f. Determine dominance for shape;

3. The method of claim 1 wherein the step of determining opposition for visual design variables comprises the steps of:
a. Determine opposition for value;
b. Determine opposition for color;
c. Determine opposition for color intensity;
d. Determine opposition for texture;
e. Determine opposition for line;
f. Determine opposition for shape;

4. The method of claim 1 wherein the step of determining balance for visual design variables comprises the steps of:
a. Determine balance for value;
b. Determine balance for color;
c. Determine balance for color intensity;
d. Determine balance for texture;
e. Determine balance for line;
f. Determine balance for shape;

5. The method of claim 1 wherein the step of determining unity for visual design variables comprises the steps of:
a. Determine unity for value;
b. Determine unity for color;
c. Determine unity for color intensity;
d. Determine unity for texture;
e. Determine unity for line;
f. Determine unity for shape;

6. The method of claim 1 wherein the step of determining rhythm for visual design variables comprises the steps of:
a. Determine rhythm for value;
b. Determine rhythm for color;
c. Determine rhythm for color intensity;
d. Determine rhythm for texture;
e. Determine rhythm for line;
f. Determine rhythm for shape;

7. The method of claim 1 wherein the step of providing visual bars, balance symbol and narrative summaries that describes the evaluation comprises the steps of:
a. Provide visual bar and balance symbol for value;
b. Provide visual bar and balance for color;
c. Provide visual bar and balance symbol for color intensity;
d. Provide visual bar and balance symbol for texture;
e. Provide visual bar and balance symbol for line;
f. Provide visual bar and balance symbol for shape;
g. Provide narrative summary for unity;
h. Provide narrative summary for rhythm;
i. Provide narrative summary for visual design;

8. A method for identifying possible changes which will improve harmony, wherein said method comprises the steps of:
a. Determining if more or less dominance will improve harmony;
b. Determining if more or less opposition will improve harmony;
c. Determining if better balance will improve harmony;
d. Determining if more or less unity will improve harmony;
e. Determining if more or less rhythm will improve harmony;
f. Providing visual bars, balance symbol, change symbol and narratives which describes proposed changes;

9. The method of claim 8 wherein the step of determining if more or less dominance will improve harmony comprises the steps of:
a. Determine if more or less dominance for value will improve harmony;
b. Determine if more or less dominance for color will improve harmony;
c. Determine if more or less dominance for color intensity will improve harmony;
d. Determine if more or less dominance for texture will improve harmony;
e. Determine if more or less dominance for line will improve harmony;
f. Determine if more or less dominance for shape will improve harmony;

10. The method of claim 8 wherein the step of determining if more or less opposition will improve harmony comprises the steps of:
a. Determine if more or less opposition for value will improve harmony;
b. Determine if more or less opposition for color will improve harmony;
c. Determine if more or less opposition for color intensity will improve harmony;
d. Determine if more or less opposition for texture will improve harmony;
e. Determine if more or less opposition for line will improve harmony;
f. Determine if more or less opposition for shape will improve harmony;

11. The method of claim 8 wherein the step of determining if better balance will improve harmony comprises the steps of:
a. Determine if better balance for value will improve harmony;
b. Determine if better balance for color will improve harmony;
c. Determine if better balance for color intensity will improve harmony;
d. Determine if better balance for texture will improve harmony;
e. Determine if better balance for line will improve harmony;
f. Determine if better balance for shape will improve harmony;

12. The method of claim 8 wherein the step of determining if more or less unity will improve harmony the steps of:
a. Determine if more or less unity for value will improve harmony;
b. Determine if more or less unity for color will improve harmony;
c. Determine if more or less unity for color intensity will improve harmony;
d. Determine if more or less unity for texture will improve harmony;
e. Determine if more or less unity for line will improve harmony;
f. Determine if more or less unity for shape will improve harmony;

13. The method of claim 8 wherein the step of determining if more or less rhythm will improve harmony comprises the steps of:
a. Determine if better rhythm for value will improve harmony;
b. Determine if better rhythm for color will improve harmony;
c. Determine if better rhythm for color intensity will improve harmony;
d. Determine if better rhythm for texture will improve harmony;
e. Determine if better rhythm for line will improve harmony;
f. Determine if better rhythm for shape will improve harmony;

14. The method of claim 8 wherein the step of providing visual bars, balance symbol, change symbol and narratives which describes proposed changes comprises the steps of:
a. Provide visual bar, balance symbol, change symbol for changes to value;
b. Provide visual bar, balance symbol, change symbol for changes to color;
c. Provide visual bar, balance symbol, change symbol for changes to color intensity;
d. Provide visual bar, balance symbol, change symbol for changes to texture;
e. Provide visual bar, balance symbol, change symbol for changes to line;
f. Provide visual bar, balance symbol, change symbol for changes to shape;
g. Provide narrative summary for changes to unity;
h. Provide narrative summary for changes to rhythm;
i. Provide narrative summary for changes to overall visual design;
